(19) United States
(12) Patent Application Publication
(10) Pub. No.: US 2022/0345444 A1
(43) Pub. Date: Oct. 27, 2022

(54) METHOD FOR PROVIDING AND VALIDATING ALTERNATIVE OBJECT IDENTIFIERS AND FOR DETERMINING REFERENCES OF ALTERNATIVE OBJECT IDENTIFIERS WITHIN AN OPC-UA-BASED COMMUNICATION ENVIRONMENT

(71) Applicant: Phoenix Contact GmbH & Co. KG, Blomberg (DE)

(72) Inventor: Oliver THEIS, Kalletal (DE)

(21) Appl. No.: 17/763,462

(22) PCT Filed: Sep. 21, 2020
(86) PCT No.: PCT/EP2020/076224

§ 371 Date: Mar. 24, 2022

(30) Foreign Application Priority Data
Sep. 25, 2019 (LU) LU101410

(51) Int. Cl. H04L 61/45; H04W 4/70

(52) U.S. Cl. CPC H04L 61/4553; H04L 61/457; H04W 4/70

(57) ABSTRACT

A method for providing alternative object identifiers for objects of an address space of a server within an OPC UA based communication environment, wherein each object of the address space of the server is uniquely identified by a conventional object identifier, wherein at least one additional identifier is defined and is stored in a directory of additional identifiers defined for this address space of the server, and wherein an alternative object identifier also uniquely identifying the object is formed for each object of the address space of the server, whereby the additional identifier is combined with the conventional object identifier of the respective object according to a determined pattern. Another method for validating alternative object identifiers and a method for determining references of object identifiers, as well as a server, a system, and a computer program product designed to carry out at least one of the methods.

### CROSS REFERENCE

This application claims the benefit under 35 U.S.C. § 371 of International Application No. PCT/EP2020/074059, filed on Aug. 28, 2020, which in turn claims the benefit of Luxembourg Application No. LU 101410, filed on Aug. 30, 2019, the entire contents of which are hereby incorporated by reference in their entirety.

### FIELD

Embodiments of the present invention relate to a method for providing alternative object identifiers for objects of an address space of a server within an OPC UA based communication environment, a method for validating such alternative object identifiers, and a method for determining references of such alternative object identifiers. Embodiments of the present invention also relate to a server, a system, and a computer program product, which are adapted to perform at least one of these methods.

### BACKGROUND

IEC 62541 is a multi-part standard for OPC Unified Architecture (OPC UA), which defines, for example, protocols for so-called machine-to-machine (M2M) communication, which is to say for the automated exchange of information between terminal devices such as machines or automatons.

OPC UA is subject to a client-server model, which is to say servers provide information that clients request from the servers. The functionality of a server is made available to the clients by means of so-called services. A service enables access to certain aspects of the server by means of request/response messages defined for the respective service, which messages are exchanged between the client and the server. In so doing, the information is provided by a server to the clients in an address space of the server.

In particular, according to the version valid at the filing date, Part 3 of the IEC 62541 standard (“Address Space Model”) defines an object-oriented concept of an address space, wherein, in particular, according to the version valid at the filing date, objects are represented by nodes pursuant to part 4 of the standard (“Services”). Nodes, on the one hand, have attributes and, on the other hand, references, that point to other nodes and represent the edges of a directed graph, so that there can be forward and backward references.

Clients in a UPC UA based communication environment can browse through such an address space provided by a server in order to determine the unique identifier of another node (hereinafter also referred to as NodeID) starting from a known root node. By means of the specified services, such as “DataAccess”, OPC UA clients, for example, get read access or write access to attribute values of a node of an address space.

NodeIDs are usually composed of the three elements “namespaceIndex”, “identifierType” and “identifier”. The “identifierType” element defines the type of the unique identifier, which can be NUMERIC, STRING, GUID [globally unique identifier] or BYTESTRING. For the uniqueness of each NodeID, each node of the address space must have a unique identifier defined as the “identifier” element according to the defined identifier type. In order to avoid clashes in addresses or identifiers and to further subdivide the address space, an address space may comprise several name spaces. The respective namespace of the node must be given as “namespaceIndex” element of the NodeID for each address space of the node. A directory of all namespaces or namespace indices of an address space is stored as attribute to a known node such as the root node.

One possible application of an OPC UA server is, for example, in the field of automation technology, to provide OPC UA clients with access to variables of a programmable logic control (PLC). By way of example, in controls based on the PLCnext Technology of the applicant, the variables of the components are listed as nodes of an address space of an OPC UA server, wherein the STRING identifier type is defined for the unique node identifiers (cf. FIG. 8). The directory of all namespaces or namespace indices of the address space is stored as “NamespaceArray” attribute of the “Server” node (cf. FIG. 9).

Until now, it however became problematic if several information models, such as, in particular, different semantic representations were to be dynamically implemented for the same dataset of an OPC UA address space or if changes were to be made in the address space over the course of time which had effects on existing NodeIDs.

The namespaces mentioned above do indeed allow structuring of an address space. However, they are static in nature and would require a replication of nodes or node instances in another namespace in order to implement multiple information models for the same dataset of an OPC UA address space.

The concept of OPC UA views does indeed allow the organization and tailoring of address spaces to specific tasks and applications cases. However, they do rather serve as entry points or filters for an address space.

In this way, there is a need to provide a way to overcome at least one of said disadvantages.

SUMMARY Embodiments of the present invention propose a method having the features of independent claim 1, a method having the features of independent claim 6, as well as a method having the features of independent claim 9. Embodiments of the present invention moreover propose a server according to independent claim 14, a system according to independent claim 15, as well as a computer program product according to independent claim 16.

Further embodiments of the control arrangement are given in the dependent claims.

Embodiments of the present invention are based, in part, on the idea of enabling several different representations of the same data set of an OPC UA address space by means of a new addressing pattern, which can, in particular, be implemented in addition to the conventional addressing pattern. This allows different information models and, in particular, access to objects or nodes in different contexts. The new addressing pattern is based on alternative object identifiers, which essentially combine the existing conventional object identifiers with an additional identifier, wherein the alternative identifier is to be understood as a representative, alias or synonym of the conventional identifier of an object or node. An advantage of embodiments of the present invention, which will be explained in more detail later, is thereby that an OPC UA server requires essentially no additional computing or memory resources to implement this new addressing pattern.

Accordingly, a method is proposed for providing alternative object identifiers for objects of an address space of a server within an OPC UA based communication environment (K), wherein each object of the address space of the server is uniquely identified by a conventional object identifier. In so doing, at least one additional identifier is defined and is expediently stored in a directory of the additional identifiers defined for this address space of the server. In addition, in so doing, an alternative object identifier, which also uniquely identifies the object, is formed for each object of the address space of the server by combining, according to a determined pattern, the additional identifier with the conventional object identifier of the respective object.

In this method, as well as in the other methods according to another embodiment of the present invention, the objects may be represented by nodes, so the object identifiers are node identifiers (NodeIDs). Furthermore, an address space can be subdivided into namespaces, whereby the respective method can be applied or executed for the objects or nodes of one namespace or several, in particular, all namespaces of an address space.

Advantageously, a user can clearly recognize the alternative object identifiers as such and easily distinguish them from conventional object identifiers.

The alternative object identifiers offer great flexibility with regard to changes in the address space that may eventually become necessary over time, such as the assignment of new identifiers for existing objects or nodes, this since, thanks to the new addressing pattern, such changes do not affect the conventional object or node identifiers, but rather only the alternative object or node identifiers.

Another advantage is that the alternative object identifiers can be handled in the same way as the conventional object identifiers from the point of view of the OPC UA protocol.

According to an embodiment of the method, the pattern provides that if the conventional object identifier is of the STRING identifier type, the additional identifier is also of the STRING identifier type and comprises two additional identifier parts, wherein the first additional identifier part is a freely definable character string and the second additional identifier part is a freely definable separator character.

In an expedient further development, the pattern provides that the alternative object identifier is also of the STRING identifier type and is formed of the three parts: first additional identifier part, second additional identifier part and conventional object identifier of the respective object in this or reverse combination order.

As a consequence, the new addressing pattern is very easy to implement for address spaces with conventional object identifiers of the STRING identifier type.

According to another embodiment of the method, the pattern provides that if the conventional object identifier is of the NUMERIC identifier type, the additional identifier is also of the NUMERIC identifier type and is a multiple of a base value, wherein the base value is greater than the largest numeric value, increased by 1, of all the conventional object identifiers of the objects of the address space of the server.

In an expedient further embodiment, the pattern provides that the alternative object identifier is also of the NUMERIC identifier type and is formed by adding the additional identifier and the conventional object identifier of the respective object. In this case, the alternative object identifier thus corresponds to the sum of the numerical values of the additional identifier and the conventional object identifier.

As a consequence, the new addressing pattern is also very easy to implement for address spaces with conventional object identifiers of the NUMERIC identifier type.

Also proposed is a method for validating an alternative object identifier within an OPC-UA based communication environment, wherein each object of an address space of a server is uniquely identified by a conventional object identifier and is additionally uniquely identified by at least one alternative object identifier, comprising the steps of:
extracting an alternative object identifier from a request from a client,
dividing the alternative object identifier according to a certain pattern using a division criterion, such that a conventional object identifier and an additional object identifier are subsequently present,
judging that the conventional object identifier is valid, if it can be identified in a directory of conventional object identifiers existing in this address space of the server,
judging that the additional identifier is valid, if it can be identified in a directory of the additional identifiers defined for this address space of the server,
judging that the alternative object identifier is valid, if both the conventional object identifier and the additional identifier were previously judged to be valid,
judging that the alternative object identifier is not valid if the conventional object identifier and/or the additional identifier were previously judged to not be valid.

Since the request of an OPC UA client could in principle contain any object identifier, it must first, in particular on the part of the OPC UA server, be validated that the requested alternative object identifier is indeed a valid one, this by validating that the additional identifier contained therein is valid and that the conventional object identifier contained therein is indeed part of the address space.

According to a first embodiment of the method, the pattern provides that if the alternative object identifier is of the STRING identifier type, a separator character is used as the division criterion, and the separator character is identified within the entire string of the alternative object identifier as the second additional identifier part, and wherein the part of the character string before the separator character is identified as the first additional identifier part and the part of the character string after the separator character is identified as the conventional object identifier and is processed further, or the part of the character string before the separator character is identified as the conventional object identifier and the part of the character string after the separator character is identified as the first additional identifier part and is processed further.

According to another embodiment of the method, the pattern provides that if the alternative object identifier is of the NUMERIC identifier type, a base value is used as the division criterion and the alternative object identifier is divided by the base value, wherein the integer quotient of this division, in particular after being multiplied once again by the base value base, is identified and processed further as additional identifier, and the remainder of this division is identified and processed further as the conventional object identifier.

As a consequence, it is possible to validate requested object identifiers of the STRING identifier type as well as also of the NUMERIC identifier type.

If the alternative object identifier is of the STRING identifier type, the separator to be used as a division criterion for dividing the alternative object identifier can, for example, be determined in the source code, in particular in the source code for a so-called NodeID parser. Alternatively, the division criterion to be used may, for example, also be set up as a configurable parameter.

Even if the alternative object identifier is of the NUMERIC identifier type, the base to be used as a division criterion for dividing the alternative object identifier can, for example, be determined in the source code, in particular in the source code for a so-called NodeID parser. In so doing, the value of the base should be chosen as large as possible, such that an overlap of the NodeIDs of different information models of a namespace is as unlikely as possible. OPC UA specifies UINT32 as data type for numeric NodeIDs, such that (2\hat{ }32−1)/Y can be selected as maximum value of the base, wherein Y indicates the maximum possible number of different dimensions or information models. If, on the other hand, the value of the base is to be set minimally small, then the maximum number of nodes in the address space must be known and observed. Alternatively, the division criterion to be used can, for example, also be set up as a configurable parameter.

If the alternative object identifier is of the STRING identifier type, a directory of the defined additional identifiers can be set, for example, as a list or array in the source code, in particular in the source code for a so-called NodeID parser.

Even if the alternative object identifier is of the NUMERIC identifier type, a directory of the defined additional identifiers can be set, for example, as a list or array in the source code, in particular in the source code for a so-called NodeID parser.

In accordance with another embodiment of the present invention, there is provided a method for determining references of an alternative object identifier within an OPC UA based communication environment, wherein each object of an address space of a server is uniquely identified by a conventional object identifier and is additionally uniquely identified by at least one alternative object identifier, comprising the steps of:
extracting an alternative object identifier from a request from a client,
dividing the alternative object identifier according to a certain pattern using a division criterion, such that a conventional object identifier and an additional object identifier are subsequently present,
determining the references associated with the conventional object identifier in a directory of the references present in this address space of the server, wherein each reference comprises a conventional object identifier of an associated other object,
for each reference determined, forming of an alternative object identifier by combining the additional identifier with the conventional object identifier of the associated other object comprised by the reference according to a certain pattern.

The request of an OPC UA client can be directed to determine the references for a requested alternative object identifier. This method generates an alternative object identifier for each determined reference through the use of the additional identifier contained in the requested alternative object identifier. The information model used by the client is therefore taken into account when answering the query. In so doing, the method can advantageously be applied or executed both for forward references and for backward references.

According to an embodiment of the method, the pattern provides that if the alternative object identifier, the references of which are to be determined, is of the STRING identifier type, a separator character is used as a division criterion, and the separator character within the string of the alternative object identifier is identified as a second additional identifier part, and wherein the part of the character string before the separator character is identified as the first additional identifier part and the part of the character string after the separator character is identified as the conventional object identifier and is processed further, or the part of the character string before the separator character is identified as the conventional object identifier and the part of the character string after the separator character is identified as the first additional identifier part and is processed further.

According to a further development of the method, the pattern provides that for each determined reference, the alternative object identifier is also of the STRING identifier type and is formed of three parts, namely in the order:

first additional identifier part, second additional identifier part and conventional object identifier of the respective associated other object, or in the order; and

conventional object identifier of the respective associated other object, second additional identifier part and first additional identifier part.

According to another embodiment of the method, the pattern provides that if the alternative object identifier, the references of which are to be determined, is of the NUMERIC identifier type, a base value is used as the division criterion and the alternative object identifier is divided by the base value, wherein the integer quotient of this division, in particular after renewed multiplication by the base value base, is processed further as an additional identifier and the remainder of this division is processed further as a conventional object identifier.

According to a further development of the method, the pattern provides that for each determined reference the alternative object identifier is also of the NUMERIC identifier type and is formed by adding the additional identifier and the conventional object identifier of the respective assigned other object.

In so doing, references can effectively be determined for requested object identifiers of the STRING identifier type as well as also of the NUMERIC identifier type.

Furthermore, a server is proposed, in particular an OPC UA server, which is designed to carry out at least one of the methods according to the invention described above.

Also proposed is a system comprising an OPC UA based communication environment with at least one server according to an embodiment of the present invention, as described above, and with at least one client, which are interconnected via a network.

Lastly, a computer program product is also proposed, said computer program product comprising instructions which, when executed by a computer, in particular a server, cause it to execute at least one of the methods according to embodiments of the present invention described above.

The features and advantages indicated for the methods according to embodiments of the present invention also apply analogously to the server, as well as, to the system, and the computer program product.

### BRIEF DESCRIPTION OF THE DRAWINGS

These and further features and advantages of embodiments of the present invention also result from the examples, which are explained in more detail below with reference to the accompanying drawings. The figures are schematic representation wherein:

FIG. 1 shows a system with an OPC UA based communication environment;

FIG. 2 shows a first example of a method for providing an alternative object identifier;

FIG. 3 shows a first example of a method for validating an alternative object identifier;

FIG. 4 shows a first example of a method for determining references of an alternative object identifier;

FIG. 5 shows a second example of a method for providing an alternative object identifier;

FIG. 6 shows a second example of a method for validating an alternative object identifier;

FIG. 7 shows a second example of a method for determining references of an alternative object identifier;

FIG. 8 shows an address space of an OPC UA server, wherein the component variables of a controller are listed as nodes with unique node identifiers of the STRING identifier type;

FIG. 9 shows an address space of an OPC UA server, wherein the directory of all namespaces or namespace indices of the address space is stored as “NamespaceArray” attribute of the “Server” node;

FIG. 10 shows a first example of a listing of conventional object identifiers and alternative object identifiers for objects or nodes of an address space, which represent variables of the “Arp.PLC.Eclr” control component in different information models; and

FIG. 11 shows a second example of a listing of conventional object identifiers and alternative object identifiers for objects or nodes of an address space, which represent variables of the “Arp.PLC.Eclr” control component in different information models.

### DETAILED DESCRIPTION

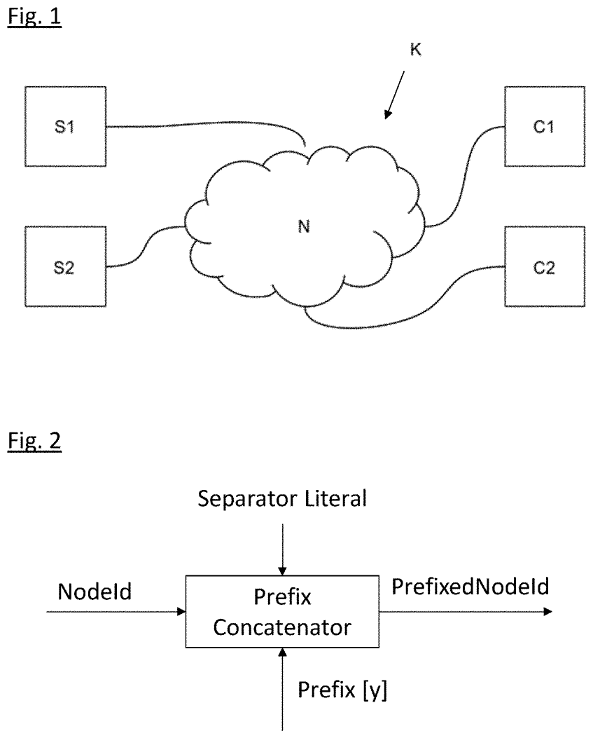

FIG. 1 shows, by way of example, a system with an OPC UA based communication environment K, which here has two servers S1 and S2 as well as two clients C1 and C2, which are connected to each other via a network N. In so doing, the clients are designed as OPC UA clients and the servers as OPC UA servers. The servers are moreover designed to carry out the methods according to the invention for the provision, validation, and determination of references of alternative object identifiers, wherein the individual methods are explained in more detail below. The servers S1 and S2 provide their information to the clients C1 and C2 in an address space.

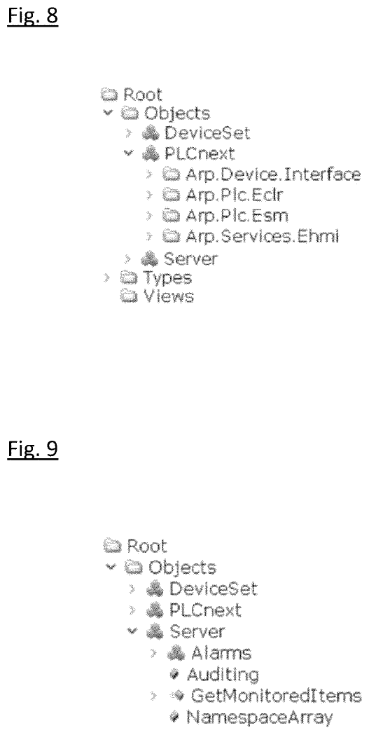

FIG. 8 shows, by way of example, a part of the address space of the OPC UA server S1. In the drawing, the component variables of a PLCnext Technology controller (that is not shown) to which at least the server S1 is connected, are listed as nodes with unique conventional node identifiers of the STRING identifier type. FIG. 9 shows another part of the address space of the OPC UA server S1, wherein it can here be recognized that the directory of all namespaces or namespace indices of the address space is stored as “NamespaceArray” attribute of the “Server” node.

The OPC UA standard does not specify how a server is required to manage the nodes. It is assumed that the address space is divided into namespaces N[x], wherein the conventional NodeID node identifiers are in a namespace N[x] of the identifierType=STRING identifier type or of the identifierType=NUMERIC identifier type. It is further assumed that the server uses an array-like structure called NodeIDArray to store valid NodeID node identifiers and uses a map-like structure called Forward-/BackwardReferenceMap to store references, which is to say arrays of NodeID node identifiers of the references to each NodeID node identifier. However, these assumptions have been made exclusively to simplify the description of the embodiments of the present invention and are not meant to limit the invention.

Embodiments of the present invention aims at extending an existing address space, in particular within a namespace N[x], by a dimension y having y=1 . . . Y, and this at low costs or minimal effort, which is to say without replication of node instances in a memory, in particular without adding new elements to the NodeIDArray or the Forward/BackwardReferenceMap. In this way, embodiments of the present invention enable the implementation of Y additional information models or contexts for a dataset.

For this purpose, embodiments of the present invention propose a new addressing pattern that has already been mentioned here above.

In the case of a conventional NodeID node identifier of the identifierType=STRING identifier type in a namespace N[x], a new or alternative PrefixedNodeID node identifier of the same identifier type is defined, which is formed, as shown in FIG. 2, by combination or concatenation (cf. prefix concatenator) of a first part of an additional Prefix[y] identifier and a second part of an additional identifier in the form of a separator literal with the conventional NodeID node identifier, where Prefix[y] is an element of the Prefix[Y] set with index y=1:Y.

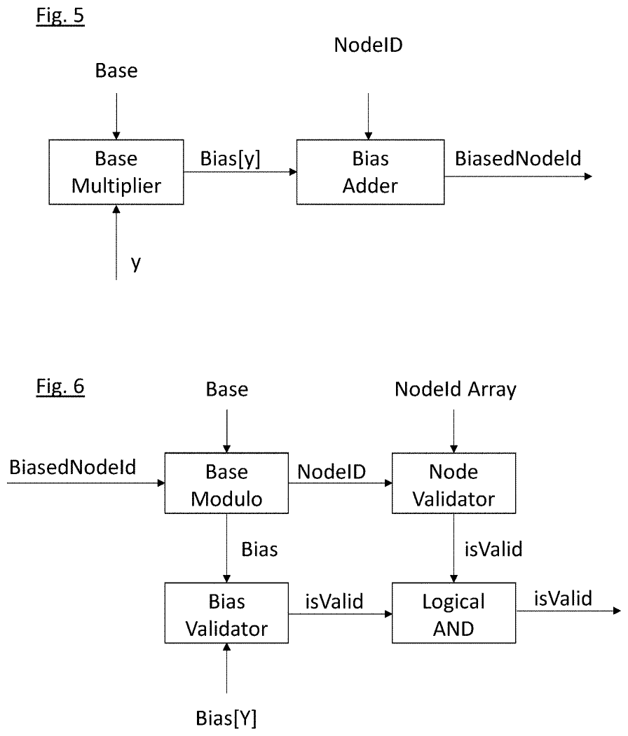

In the case of a conventional NodeID node identifier of the identifierType=NUMERIC identifier type in a namespace N[x], a new or alternative BiasedNodeID node identifier of the same identifier type is defined, which is formed as shown in FIG. 5 by the combination or addition (cf. bias adder) of an additional identifier Bias[y] and the conventional NodeID node identifier, wherein Bias[y] is an element of the set Bias[Y] with index y=1:Y, and wherein Bias[y] is the product of the multiplication of a base value base by y (cf. base multiplier), wherein the base value base is larger than the largest numerical value, increased by 1, of all the conventional NodeID node identifiers in the namespace N[x].

If, for example, the namespace N[x] contains 10 nodes with NodeID node identifiers=1 . . . 9, then the base value base can be=100, since 100>max (0 . . . 9) is valid, such that for Y=3, it results in alternative biased NodeID node identifiers=(100 . . . 109, 200 . . . 209, 300 . . . 309).

In general terms, in this way, a method is provided for the provision of alternative object identifiers for objects of an address space, in particular of a name space, of a server S1, S2 within an OPC UA based communication environment K, wherein each object of the address space of the server S1, S2 is uniquely identified by a conventional object identifier, wherein at least one additional identifier is defined and stored in a directory of the additional identifiers defined for this address space of the server S1, S2, and wherein for each object of the address space of the server S1, S2, an alternative object identifier is formed according to a determined pattern, which identifier also uniquely identifies the object by combining the additional identifier with the conventional object identifier of the respective object.

In an embodiment of the method, the pattern provides that if the conventional object identifier is of the STRING identifier type, the additional identifier is also of the STRING identifier type and comprises two additional identifier parts, the first additional identifier part being a freely definable character string and the second additional identifier part being a freely definable separator character. Furthermore, the pattern provides that the alternative object identifier is also of the STRING identifier type and is formed of three parts: first additional identifier part, second additional identifier part and conventional object identifier of the respective object, in this combination order (cf. FIG. 2).

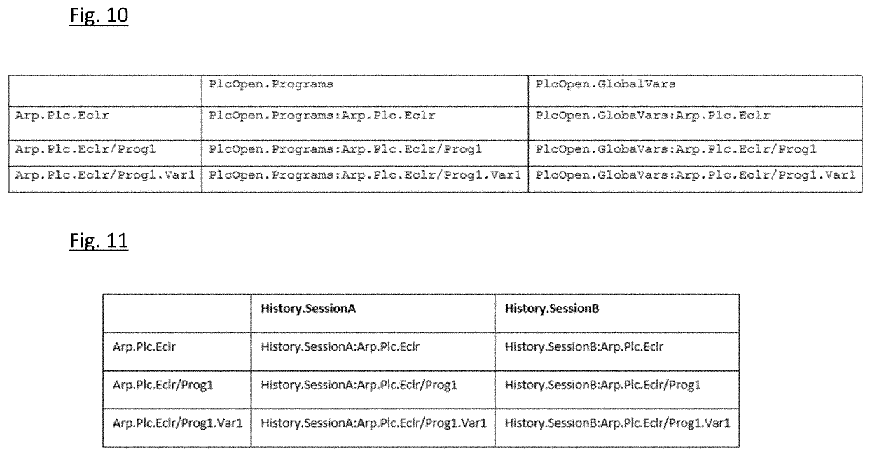

Exemplary results of this method are shown in FIG. 10 and FIG. 11.

FIG. 10 shows a list of conventional object identifiers and alternative object identifiers for objects or nodes of an address space, which represent variables of the “Arp.PLC.Eclr” control component in different information models. On the one hand, the additional identifier “PlcOpen.Programs” was defined to provide an information model for program variables. On the other hand, the additional identifier “PlcOpen.GlobalVars” has been defined to provide an information model for global variables. In both cases, the additional identifier also includes the “:” separator character.

FIG. 11 shows another list of conventional object identifiers and alternative object identifiers for objects or nodes of an address space, which represent variables of the “Arp.PLC.Eclr” control component in yet again different information models. On the one hand, the additional identifier “History.SessionA” was defined here for an information model for accessing historical values of these variables, which were recorded in a session A with a first sampling rate. On the other hand, the additional identifier “History.SessionB” has been defined for an information model to access historical values of these variables, which have been captured in a Session B with a second sampling rate. In both cases, the additional identifier also again includes the “:” separator character.

In the examples according to FIG. 2, FIG. 10 and FIG. 11, the additional identifier is provided as a prefix to the conventional object identifier. However, it would also be conceivable to provide the additional identifier as a suffix to the conventional object identifier.

In an alternative embodiment of the method, the pattern provides that if the conventional object identifier is of the NUMERIC identifier type, the additional identifier is also of the NUMERIC identifier type and is a multiple of a base value, wherein the base value is greater than the largest numerical value, increased by 1, of all the conventional object identifiers of the objects of the address space of the server S1, S2. Furthermore, the pattern provides that the alternative object identifier is also of the NUMERIC identifier type and is formed by adding the additional identifier and the conventional object identifier of the respective object (cf. FIG. 5).

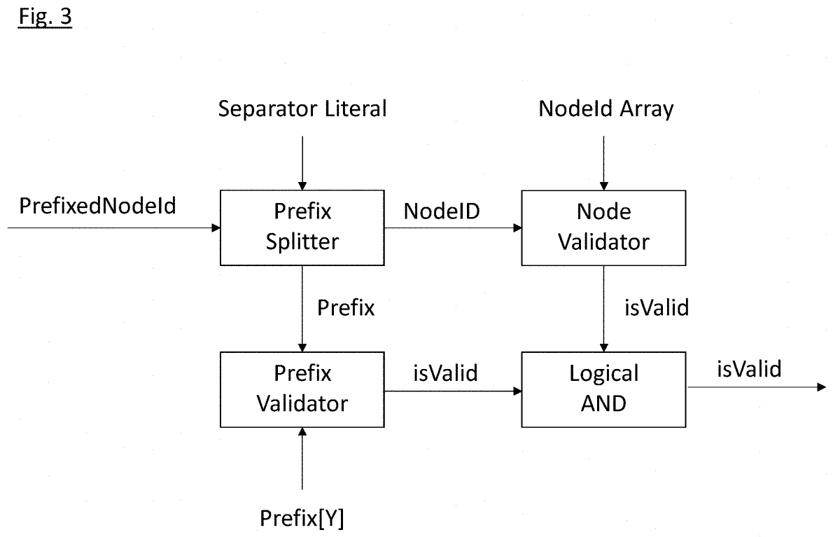

FIG. 3 and FIG. 6 show two examples of a method for validating an alternative object identifier within an OPC UA based communication environment K, wherein each object of an address space of a server S1, S2 is uniquely identified by a conventional object identifier and is additionally uniquely identified by at least one alternative object identifier. In general, the method comprises the steps of:
extracting an alternative PrefixedNodeID or BiasedNodeID object identifier from a request of a client C1, C2,
dividing the alternative object identifier according to a specific pattern making use of a division criterion, such that subsequently a conventional NodeID object identifier and a prefixed or biased additional identifier are available,
judging that the conventional NodeID object identifier is valid, if it can be identified in a NodeIDArray directory of conventional object identifiers existing in this address space of the server S1, S2 (cf. node validator),
judging that the additional identifier is valid, if it can be identified in a prefix[Y] or bias[Y] directory of the additional identifiers defined for this address space of the server S1, S2 (cf. prefix validator or bias validator),
judging that the alternative object identifier is valid, if both the conventional object identifier and the additional identifier were previously judged to be valid (cf. Logical AND),
judging that the alternative object identifier is not valid if the conventional object identifier and/or the additional identifier were previously judged to not be valid.

According to an embodiment of the method (cf. FIG. 3), the pattern provides that if the alternative object identifier is of the STRING identifier type, a separator literal character is used as a division criterion and the separator character is identified within the entire string of the alternative PrefixedNodeID object identifier as a second additional identifier part, wherein the part of the string before the separator character is identified as the first additional prefixed identifier part and the part of the string after the separator character is identified and processed further as the conventional NodeID object identifier (cf. prefix splitter).

In a case not shown in the figures, it could instead be provided that the part of the character string before the separator character is identified and processed further as a conventional object identifier and the part of the character string after the separator character is identified and processed further as a first additional identifier part.

According to another embodiment of the method (cf. FIG. 6), the pattern provides that if the alternative object identifier is of the NUMERIC identifier type, a base value base is used as a division criterion and the alternative BiasedNodeID object identifier is divided by the base value base, wherein the integer quotient of this division, in particular after renewed multiplication by the base value base, is identified and processed further as the additional bias identifier and the remainder of this division is identified and processed further as the conventional NodeID object identifier (cf. Base Modulo). In FIG. 6, the renewed multiplication of the integer quotient with the base value base is not shown.

The integer quotient itself, corresponds to the index y of the dimension or the information model.

Due to this step-by-step validation according to embodiments of the present invention, the validation of alternative object identifiers can be carried out very efficiently. And since in the provision of alternative object identifiers for an additional information model according to embodiments of the present invention, only a new additional identifier is entered into the directory of additional identifiers, but no node instances are replicated, the validation of alternative object identifiers requires virtually no additional storage space and computing power or time. In this way, the embodiments of the present invention enable implementation of Y additional information models or contexts for a dataset without increasing memory and computing power or time requirements by a factor of Y+1.

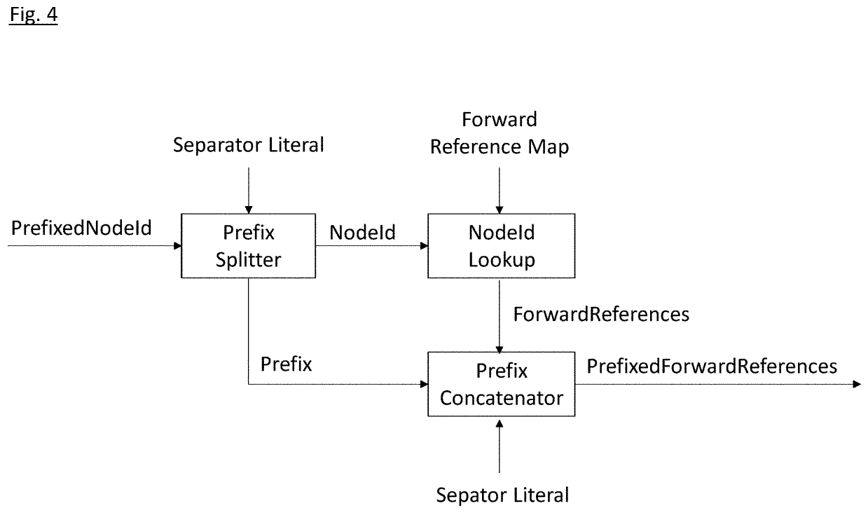

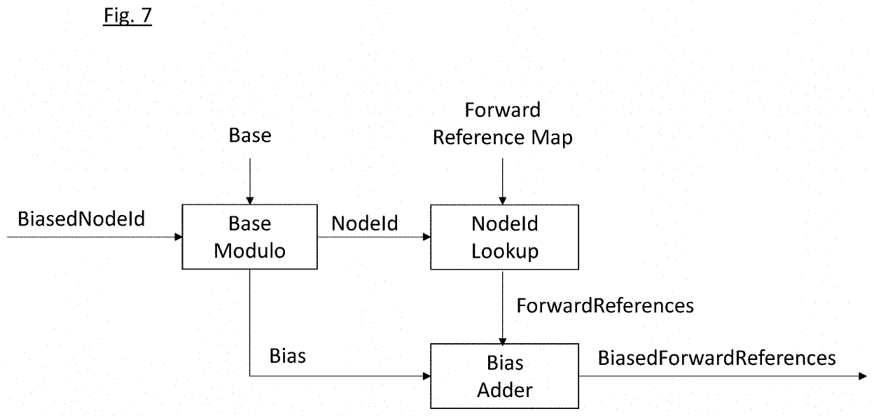

FIG. 4 and FIG. 7 show two examples of a method for determining references of an alternative object identifier within an OPC UA based communication environment K, wherein each object of an address space of a server S1, S2 is uniquely identified by a conventional object identifier and is additionally uniquely identified by at least one alternative object identifier. In general, the method comprises the steps of:
extracting an alternative PrefixedNodeID or BiasedNodeID object identifier from a request of a client C1, C2,
dividing the alternative object identifier according to a determined pattern using a division criterion so that a conventional NodeID object identifier and an additional prefixed or biased identifier are subsequently available,
determining the references assigned to the conventional NodeID object identifier in a ForwardReferenceMap directory of the references present in this address space of the server S1, S2, wherein each reference comprises a conventional object identifier of an assigned other object (cf. NodeID lookup),
for each determined ForwardReferences reference, forming of an alternative PrefixedForwardReferences or BiasedForwardReferences object identifier through the combination of the additional prefix or bias identifier with the conventional object identifier of the associated other object comprised according to a certain pattern by the ForwardReferences reference (cf. prefix concatenator or bias adder).

According to an embodiment of the method (cf. FIG. 4), the pattern provides that if the alternative PrefixedNodeID object identifier whose references are to be determined is of the STRING identifier type, a separator literal character is used as a division criterion and the separator character within the string of the alternative object identifier is identified as the second additional identifier part, and wherein the part of the string before the separator character is identified and processed further as first additional prefix identifier part and the part of the string after the separator character is identified and processed further as conventional NodeID object identifier.

In a case not shown in the figures, it could instead be provided that the part of the character string before the separator character is identified and processed further as a conventional object identifier and the part of the character string after the separator character is identified and processed further as a first additional identifier part.

Furthermore, the pattern provides that for each determined ForwardReferences reference the alternative PrefixedForwardReferences object identifier is also of the STRING identifier type and is formed of three parts in the order: first additional prefix identifier part, second additional identifier part separator literal and conventional object identifier of the respective assigned other object or in the order: conventional object identifier of the respective assigned other object, second additional identifier part and first additional identifier part.

In the example according to FIG. 4, the additional identifier occurs as a prefix to the conventional object identifier. It is, however, also conceivable that the additional identifier can appear as a suffix to the conventional object identifier.

According to another embodiment of the method (cf. FIG. 7), the pattern provides that if the alternative BiasedNodeID object identifier, whose references are to be determined, is of the NUMERIC identifier type, a base value base is used as a division criterion and the alternative object identifier is divided by the base value, wherein the integer quotient of this division is processed further as the additional bias identifier after renewed multiplication by the base value base and the remainder of this division being processed further as the conventional NodeID object identifier. In FIG. 7, the renewed multiplication of the integer quotient with the base value base is not shown. The integer quotient by itself, corresponds to the index y of the dimension or information model.

Furthermore, the pattern provides that for each determined ForwardReferences reference, the alternative BiasedForwardReferences object identifier is also of the NUMERIC identifier type and is formed by adding the additional bias identifier and the conventional object identifier of the respective assigned other object.

Even though the method according to FIG. 4 and FIG. 7 is shown and described for determining forward references, it can also be used for determining backward references.

1. A method for providing alternative object identifiers for objects of an address space of a server within an OPC UA based communication environment,
wherein each object of the address space of the server is uniquely identified by a conventional object identifier,
wherein at least one additional identifier is defined and stored in a directory of the additional identifiers defined for this address space of the server, and
wherein for each object of the address space of the server, an alternative object identifier is formed which also uniquely identifies the object by combining the additional identifier with the conventional object identifier of the respective object according to a determined pattern.

2. The method of claim 1, wherein the pattern provides that if the conventional object identifier is of the STRING identifier type, the additional identifier is also of the STRING identifier type and comprises two additional identifier parts, and
wherein the first additional identifier part is a freely definable string and the second additional identifier part is a freely definable separator character.

3. The method of claim 2, wherein the pattern provides that the alternative object identifier is also of the STRING identifier type and is formed of the three parts: first additional identifier part, second additional identifier part, and conventional object identifier of the respective object in this or reverse combination order.

4. The method of claim 1, wherein the pattern provides that if the conventional object identifier is of the NUMERIC identifier type, the additional identifier is also of the NUMERIC identifier type and is a multiple of a base value, and
wherein the base value is greater than the largest numerical value, increased by 1, of all the conventional object identifiers of the objects of the address space of the server.

5. The method of claim 4, wherein the pattern provides that the alternative object identifier is also of the NUMERIC identifier type and is formed by adding the additional identifier and the conventional object identifier of the respective object.

6. A method for validating an alternative object identifier within an OPC UA based communication environment, wherein each object of an address space of a server is uniquely identified by a conventional object identifier and is additionally uniquely identified by at least one alternative object identifier, comprising:
extracting an alternative object identifier from a request from a client;
dividing the alternative object identifier according to a certain pattern using a division criterion, such that a conventional object identifier and an additional object identifier are subsequently present;
judging that the conventional object identifier is valid, if it can be identified in a directory of conventional object identifiers existing in this address space of the server;
judging that the additional identifier is valid, if it can be identified in a directory of the additional identifiers defined for this address space of the server;
judging that the alternative object identifier is valid, if both the conventional object identifier and the additional identifier were previously judged to be valid; and
judging that the alternative object identifier is not valid if the conventional object identifier and/or the additional identifier were previously judged to not be valid.

7. The method of claim 6, wherein the pattern provides that if the alternative object identifier is of the STRING identifier type, a separator character is used as the division criterion and the separator character is identified within the entire string of the alternative object identifier as the second additional identifier part, and
wherein the part of the character string before the separator character is identified as the first additional identifier part and the part of the character string after the separator character is identified as the conventional object identifier and processed further, or the part of the character string before the separator character is identified as the conventional object identifier and the part of the character string after the separator character is identified as the first additional identifier part and processed further.

8. The method according to claim 6, wherein the pattern provides that if the alternative object identifier is of the NUMERIC identifier type, a base value is used as a division criterion and the alternative object identifier is divided by the base value, wherein the integer quotient of this division, in particular after renewed multiplication by the base value base, is identified as an additional identifier and the remainder of this division being identified and processed further as a conventional object identifier.

9. A method for determining references of an alternative object identifier within an OPC UA based communication environment, wherein each object of an address space of a server is uniquely identified by a conventional object identifier and is additionally uniquely identified by at least one alternative object identifier, comprising:
extracting an alternative object identifier from a request from a client;
dividing the alternative object identifier according to a certain pattern using a division criterion, such that a conventional object identifier and an additional object identifier are subsequently present;
determining the references associated with the conventional object identifier in a directory of the references present in this address space of the server, wherein each reference comprises a conventional object identifier of an associated other object; and
for each determined reference, forming of an alternative object identifier by combining the additional identifier with the conventional object identifier of the associated other object comprised by the reference according to a certain pattern.

10. The method of claim 9, wherein the pattern provides that if the alternative object identifier whose references are to be determined is of the STRING identifier type, a separator character is used as the division criterion and the separator character within the string of the alternative object identifier is identified as the second additional identifier part, and
wherein the part of the character string before the separator character is identified as the first additional identifier part and the part of the character string after the separator character is identified as the conventional object identifier and processed further, or the part of the character string before the separator character is identified as the conventional object identifier and the part of the character string after the separator character is identified as the first additional identifier part and processed further.

11. The method of claim 10, wherein the pattern provides that for each determined reference, the alternative object identifier is also of the STRING identifier type and is formed of three parts, namely, in the order: first additional identifier part, second additional identifier part, and conventional object identifier of the respective associated other object, or in the order: conventional object identifier of the respective associated other object, second additional identifier part, and first additional identifier part.

12. The method according to claim 9, wherein the pattern provides that if the alternative object identifier whose references are to be determined is of the NUMERIC identifier type, a base value is used as division criterion and the alternative object identifier is divided by the base value; and
wherein the integer quotient of this division, in particular after renewed multiplication by the base value base, is processed further as an additional identifier and the remainder of this division as a conventional object identifier.

13. The method of claim 12, wherein the pattern provides that for each determined reference, the alternative object identifier is also of the NUMERIC identifier type and is formed by adding the additional identifier and the conventional object identifier of the respective associated other object.

14. A server configured to perform the method according to claim 1.

15. System comprising an OPC UA based communication environment with at least one server according to claim 14 and at least one client which are interconnected via a network.

16. A computer program product comprising instructions which, when executed by a computer, cause the computer to perform the method of claim 1.
